(19) United States
(12) Patent Application Publication
(10) Pub. No.: US 2004/0146034 A1
(43) Pub. Date: Jul. 29, 2004

(54) AUDIO AND DATA MULTIPLEXED WIRELESS AUDIO SYSTEM

(76) Inventors: Chih-Sheng Chou, Ping-Tung Hsien (TW); Chat-Chin Quek, Hsin-Chu City (TW); Ho-Tsung Chang, Tao-Yuan Hsien (TW); Hsu-Hsiang Tseng, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,683

(22) Filed: Aug. 10, 2003

(30) Foreign Application Priority Data
Jan. 29, 2003 (TW) 92102063

(51) Int. Cl. H04Q 7/24

(52) U.S. Cl. 370/338; 370/463

(57) ABSTRACT

A wireless audio system for transmitting and receiving multiplexed audio and data information. The wireless audio system includes a the transmitter and a receiver that respectively include a novel apparatus for providing multiplexed audio and data delivering so that the wireless audio system can receive a plurality of input signals of various types including a digital audio input signal, an analog audio input signal, and a control input signal and output a plurality of corresponding output signals of various types including a digital audio output signal, an analog audio output signal, and a control output signal.

### BACKGROUND OF INVENTION

1. Field of the Invention

The invention relates to a wireless audio system for transmitting and receiving multiplexed audio and data information, and more particularly, to a wireless audio system for receiving a plurality of input signals of various types and for outputting a plurality of output signals of various types.

2. Description of the Prior Art

Sounds are a fundamental way in which people communicate with others. Regardless if it is voice or music, both are sent by sounds. As new technologies are developed progressively, sounds remain an important way for people to communicate or relax. Products such as audio systems are important products for people to enjoy music and relax. This is especially true of wireless audio systems. The most convenient way to transmit sounds is via air transmission. By simple operations, users can access large amount of audio information via the wireless audio systems.

Please refer to FIG. 1, which is functional block diagram of a prior-art wireless audio system 10. The wireless audio system 10 includes a transmitter 10A and a receiver 10B. The transmitter 10A can deliver an analog audio signal into free space with a form of EM waves. After the receiver 10B receives the analog audio signal, the corresponding analog audio signal can be transformed and delivered to users with acceptable forms. The transmitter 10A includes an audio source receiving device 12, an analog-to-digital converter 14, a framing unit 16, a modulation module 18, and a transmitting circuit 20. The receiver 10B includes a receiving circuit 22, a demodulation module 24, a frame synchronization controller 26, a digital-to-analog converter 28, and a detachable speaker 29.

In the transmitter 10A of the prior art, the audio source receiving device 12 can further include a microphone, and the audio source receiving device 12 can simultaneously receive two sounds inputted by different audio channels (such as left audio channel or right audio channel). These sounds are recognized as digital data bits (a sample value of each data bit represents an amplitude of the sound) and then are transmitted to the analog-to-digital converter 14 so as to generate a sequential digital signal P1. Afterwards, the framing unit 16 can add the sequential digital signal P1 with a header and a tail included with related error-protection codes to generate a frame signal P2. The frame signal P2 will be transmitted to the modulation module 18 with a form of bit stream. The modulation module 18 will modulate the frame signal P2 into an analog baseband signal P3 for wireless communication and then output the analog baseband signal P3 to the transmitting circuit 20. The transmitting circuit 20 will transform the analog baseband signal P3 into a RF signal P4 and deliver the RF signal P4 into free space.

After the receiver 10B receives the RF signal P4 emitted from the transmitter 10A, the receiving circuit 22 will first transform the RF signal P4 into a baseband signal P5 corresponding to the baseband signal P3 in the transmitter 10A, and output the baseband signal P5 to the demodulation module 24. The demodulation module 24 will derive a digital data flow P6 that corresponds to the frame signal P2 in the transmitter 10A. The frame synchronization controller 26 analyzes the digital data flow P6 according to a header and tail attached on the digital data flow P6 to identify correction of the received (frame) signal and to transform the digital data flow P6 into a standard digital audio signal P7. At the same time, the frame synchronization controller 26 will control the clock of the digital data flow P6 and synchronize the digital data flow P6 and the standard digital audio signal P7 so as to ensure the accuracy of the derived standard digital audio signal P7. The digital-to-analog converter 28 then transforms the digital audio signal P7 into an analog audio signal. Finally, the receiver 10B is installed with the speaker 29 for broadcasting the analog audio signal for users. The speaker 29 can be a stereo and an earphone.

The above-mentioned wireless audio system is widely applied and disclosed in some prior-art patents. For instance, as shown in FIG. 1, in the wireless audio system 10, the digital signal P1 should conform to a pulse-code modulation (PCM) specification, which is a standard specification for audio signal illustrated in U.S. Pat. No. 6,343,217, “Digital cordless telephony with PCM coding” issued to Borland et. al. The prior-art patent also discloses related modulating operations for a bit-stream signal conforming to the PCM specification. In addition, U.S. Pat. No. 6,483,857, “Method and apparatus for transmitting control information over an audio data stream” by Sloan et. al detailed the related transmitting and modulating operations for a bit-stream signal conforming to the PCM specification.

According to the above-mentioned prior art, the prior-art wireless audio system supports mostly analog audio signals for output and input interfaces. Users can transmit only analog audio signals with the prior-art wireless audio system with restrained flexibility for wireless audio communication. Moreover, there is a need for integrating a control data signal into the transmission of the wireless audio system with little shared transmitting bandwidth so as to provide sufficient audio communicating alternatives for users.

### SUMMARY OF INVENTION

It is therefore a primary objective of the claimed invention to provide an apparatus and a wireless audio system for receiving and outputting a plurality of signals of various types to solve the above-mentioned problems.

In the claimed invention, a novel wireless audio system is disclosed with installation of a transmitter and a receiver. The transmitter and the receiver respectively include a related apparatus for transmitting and receiving multiplexed audio and data information so that the wireless audio system of the claimed invention can receive input signals of various types and emit output signals corresponding to the input signals for users” requirement. In addition, a control signal is integrated into the wireless audio system for users to transmit and to receive analog or digital signals.

According to the claimed invention, an apparatus for transmitting and receiving multiplexed audio and data information can be adapted to a wireless audio system for receiving a plurality of input signals of various types. The plurality of input signals at least comprise an analog audio signal, a first digital audio signal, and a control signal. The apparatus comprises an analog-to-digital converter for transforming the analog audio signal to a second digital audio signal; a signal-selecting device electrically connected to the analog-to-digital converter for selecting either the first digital audio signal or the second digital audio signal for outputting; a digital-signal-format transformer electrically connected to the signal-selecting device for transforming the first digital audio signal or the second digital audio signal into a pulse audio signal; and a synthesizing module electrically connected to the digital-signal-format transformer for merging the control signal and the pulse audio signal into a digital signal of bit-stream form.

According to the claimed invention, an apparatus for transmitting and receiving multiplexed audio and data information in a wireless audio system for receiving a digital signal of bit-stream form is disclosed. The apparatus comprises a separating module for separating the digital signal of bit-stream form into a control signal and a pulse audio signal; a digital-signal-format transformer electrically connected to the separating module for transforming the pulse audio signal into a digital audio signal; a signal-judging device electrically connected to the digital-signal-format transformer for classifying the digital audio signal into either a first digital audio signal or a second digital audio signal; and a digital-to-analog converter electrically connected to the signal-judging device for transforming the second digital audio signal into an analog audio signal.

According to the claimed invention, a wireless audio system for transmitting and receiving multiplexed audio and data information comprises a transmitter for receiving a plurality of input signals of various types, the plurality of input signals at least comprising a first digital audio input signal, and a control input signal, the transmitter comprising a selecting-synthesizing device for transforming the first digital audio input signal into a transformed digital audio signal and then for merging the transformed digital audio signal with the control input signal to generate a digital input signal of bit-stream form; and a modulation module electrically connected to the selecting-synthesizing device for modulating the digital input signal of bit-stream form to generate a corresponding baseband signal; and a transmitting circuit electrically connected to the modulation module for transforming the baseband signal into a RF signal and for transmitting the RF signal to a free space; and a receiver for receiving the RF signal to output a plurality of output signals of various types, the receiver comprising a receiving circuit for receiving the RF signal so as to generate a corresponding baseband signal; a demodulation module electrically connected to the receiving circuit for demodulating the baseband signal into a digital output signal of bit-stream form; a separating-classifying device for separating the digital output signal of bit-stream form into a control output signal and a first digital audio output signal; wherein the first digital audio output signal and the control output signal respectively correspond to the first digital audio input signal and the control input signal.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a wireless audio system according to the prior art.

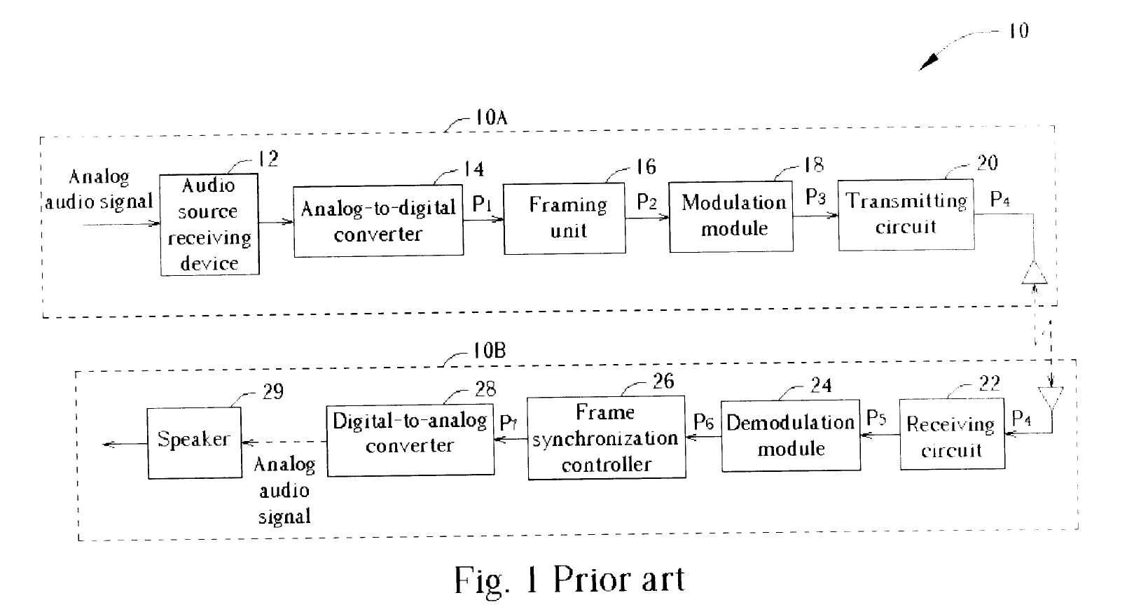

FIG. 2 is a functional block diagram of an embodiment of an apparatus according to the present invention.

FIG. 3 is a functional block diagram of a transmitter including the apparatus as shown in FIG. 2.

FIG. 4 is a functional block diagram of an embodiment of another apparatus according to the present invention.

FIG. 5 is a functional block diagram of a receiver including the apparatus as shown in FIG. 4.

FIG. 6 is a functional block diagram of a detailed embodiment of a wireless audio system of the present invention.

FIG. 7 is a functional block diagram of a detailed embodiment of the wireless audio system as shown in FIG. 6.

FIG. 8 is a functional block diagram of a detailed embodiment of partial wireless audio system shown in FIG. 7.

### DETAILED DESCRIPTION

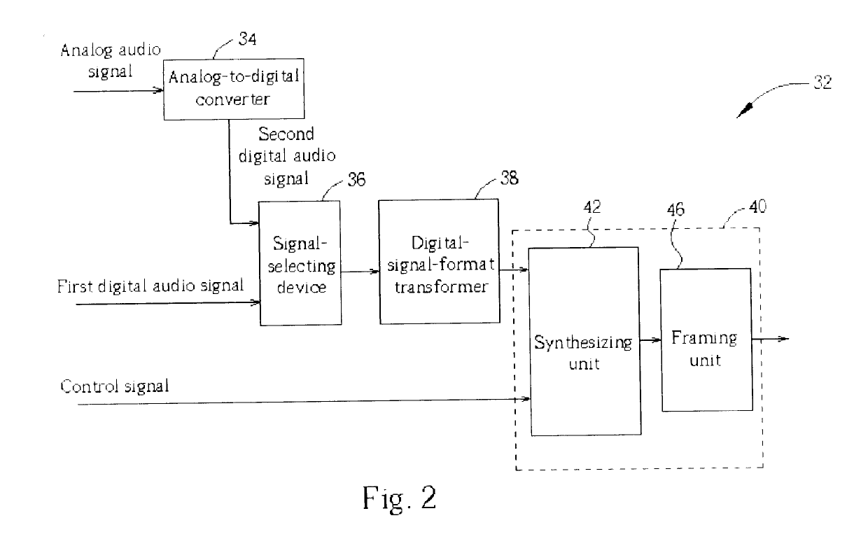

Please refer to FIG. 2, which is a functional block diagram of an embodiment of an apparatus according to the present invention. The apparatus 32 of the present embodiment can provide multiplexed audio and data transmission. The apparatus 32 can receive a plurality of input signals of various types. The plurality of input signals of the present embodiment include an analog audio signal, a first digital audio signal, and a control signal. As shown in FIG. 2, the apparatus 32 for transmitting and receiving multiplexed audio and data information includes an analog-to-digital converter 34, a signal-selecting device 36, a digital-signal-format transformer 38, and a synthesizing module 40. When the analog audio signal is inputted into the apparatus 32, the analog-to-digital converter 34 will transform the received analog audio signal into a second digital audio signal. When the digital audio signal is inputted into the apparatus 32, the analog-to-digital converter 34 will not process the digital audio signal. The signal-selecting device 36 is electrically connected to the analog-to-digital converter 34 for selecting either the first digital audio signal or the second digital audio signal for outputting. The digital-signal-format transformer 38 is electrically connected to the signal-selecting device 36 for transforming the first digital audio signal or the second digital audio signal into a pulse audio signal that conforms to a pulse-code modulation (PCM) specification. Finally, the synthesizing module 40 is electrically connected to the digital-signal-format transformer 38 for merging the control signal and the pulse audio signal into a digital signal of bit-stream form.

Please continue referring to FIG. 2. The second digital audio signal transformed from the analog audio signal conforms to I2S (Inter-IC Sound), a standard digital audio specification. Similarly, the directly received first digital audio signal should conform to some standard digital audio specifications such as I2S or SPDIF (Sony/Philips Digital Interface). After the signal-selecting device 36 chooses one from the first digital audio signal and the second digital audio signal, the picked first or second digital audio signal will be transmitted to the digital-signal-format transformer 38 for advanced data-type transformation. Please notice that, during practical implementation, the signal-selecting device 36 can be achieved by a multiplexer or other device with selecting and judging functions. The pulse audio signal generated by the digital-signal-format transformer 38 conforms to the PCM specification. Therefore, in the present embodiment, the digital-signal-format transformer 38 can transform the digital audio signals conforming to I2S or SPDIF into those conforming to the PCM specification.

During practical implementation, the digital-signal-format transformer 38 is used to transform the digital audio signals conforming to I2S or SPDIF into those conforming to the PCM specification. If the first digital audio signal only conforms to SPDIF standard digital audio specification, there is a need for a further installation of an SPDIF-to-I2S format transformer (not shown in FIG. 2) for conforming the first digital audio signal to I2S standard digital audio specification. Similarly, if the first digital audio signal conforms to a USB standard specification, another installation of an USB-to-I2S format transformer (not shown in FIG. 2) is required for conforming the first digital audio signal to I2S standard digital audio specification. Certainly, in the present embodiment, the above-mentioned SPDIF-to-I2S format transformer or USB-to-I2S format transformer can be externally set at the receiving end of the first digital audio signal or installed in the digital-signal-format transformer 38 or in the signal-selecting device 36. The second digital audio signal generated by the analog-to-digital converter 34 initially conforms to I2S standard digital audio specification without the need of another SPDIF-to-I2S transformation.

Please refer to FIG. 2. The synthesizing module 40 is one of the major characteristics of the present invention. The pulse audio signal generated by the digital-signal-format transformer 38 will be merged with the control signal to form a digital signal of bit-stream form. The control signal, which is a digital data signal, occupies less storage space than any other audio signal. In addition, the control signal is brought with some specific information for controlling audio signals. For instance, the control signal can be used to adjust the volume of sound, and to slightly adjust the transmitting frequency channels in free space for preventing any disturbance. In the present embodiment, the synthesizing module 40 is composed of a synthesizing unit 42 and a framing unit 46. After the synthesizing unit 42 receives the pulse audio signal and the control signal and then merge those both signals, the framing unit 46 adds a header and a tail included with related error-protection codes on the merged signal to generate a frame signal and to output a digital signal of bit-stream form. Therefore, the apparatus 32 of the present embodiment can receive input signals of various types to provide multiplexed audio and data transmission.

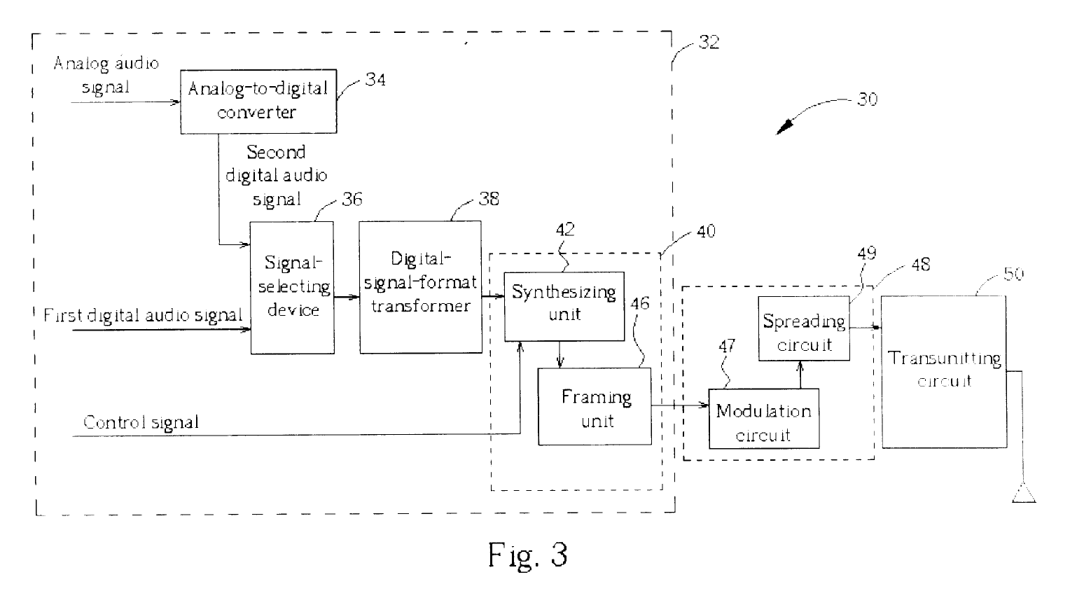

Please refer to FIG. 3, which is a functional block diagram of a transmitter 30 including the apparatus 32 as shown in FIG. 2. The transmitter 30 further includes a modulation module 48 and a transmitting circuit 50. The modulation module 48 is electrically connected to the synthesizing module 40 for modulating the digital signal of bit-stream form into a corresponding baseband signal. Actually, the modulation module 48 can be functionally divided into a modulation circuit 47 and a spreading circuit 49. The modulation circuit 47 is a π/4-DQPSK (Differential Quadrature Phase Shift Keying) modulation circuit mainly for modulating the digital signal of bit-stream form to generate a modulated signal, and the spreading circuit 49 is electrically connected to the modulation circuit 47 for executing a convolution and multiplication operation between the modulated signal and a spreading code. Briefly speaking, each bit of the modulated signal will be replaced by a plurality of bits in the spreading circuit 49 to generate the baseband signal. The baseband signal will be transformed into a RF signal by the transmitting circuit 50, and then the RF signal will be transmitted to free space with forms of EM waves.

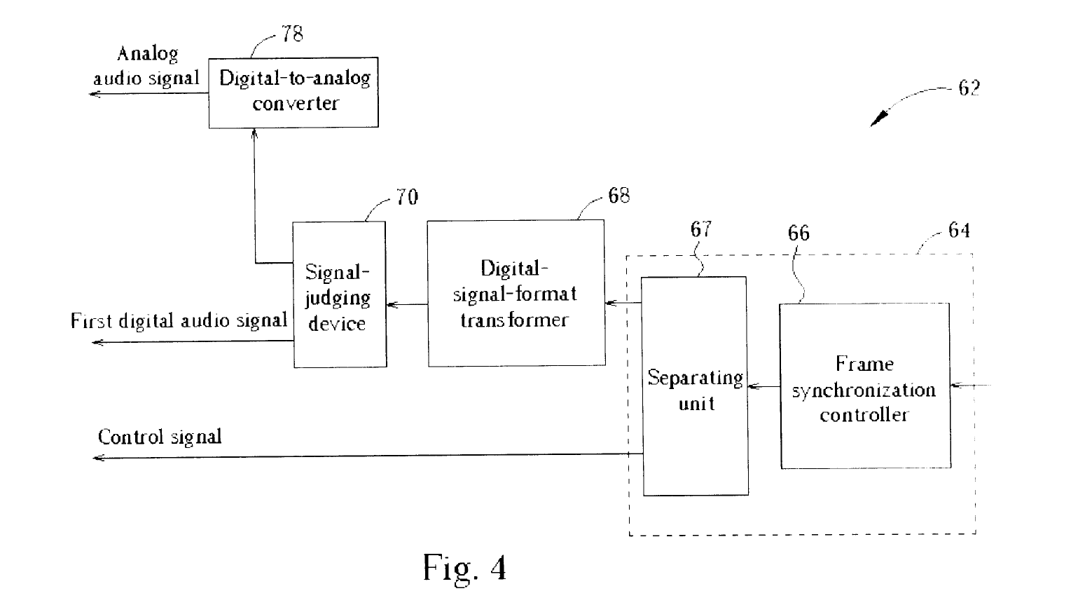

The embodiment as shown in FIG. 3 describes the infrastructure of the transmitter 30 according to the present invention. However, an integrated wireless audio system only can be achieved by adding with some devices related to data receiving. Please refer to FIG. 4, which is a functional block diagram of an embodiment of another apparatus 62. The apparatus 62 of the present embodiment is also used for transmitting and receiving multiplexed audio and data information. However, the apparatus 62 of the present embodiment is adapted to a receiver of a wireless audio system for receiving a digital signal of bit-stream form and for outputting output signals of various types by specific requirement. The apparatus 62 includes a separating module 64, a digital-signal-format transformer 68, a signal-judging device 70, and a digital-to-analog converter 78. The separating module 64 is used to separate the digital signal of bit-stream form into a control signal and a pulse audio signal. Afterwards, the digital-signal-format transformer 68 is electrically connected to the separating module 64 for transforming the pulse audio signal into a digital audio signal, and the signal-judging device 70 electrically connected to the digital-signal-format transformer 68 can classify the digital audio signal into either a first digital audio signal or a second digital audio signal. Finally, the digital-to-analog converter 78 is electrically connected to the signal-judging device 70 for transforming the second digital audio signal into an analog audio signal. Therefore, the apparatus 62 of the present embodiment can output a plurality of output signals of various types, including digital audio signals, analog audio signals, and a control signal brought with specific controlling information.

Moreover, in the present embodiment, due to that the first digital audio signal can be I2S, SPDIF, or USB standard digital audio specifications, and the digital audio signal generated by the digital-signal-format transformer 68 should conform to I2S or SPDIF specification, there is a need for a further installation of a I2S-to-SPDIF format transformer when the apparatus 62 outputs a digital audio signal conforming to SPDIF specification. Similarly, if the first digital audio signal should conform to a USB standard specification, another installation of an I2S-to-USB format transformer is required. Certainly, in the present embodiment, the above-mentioned I2S-to-SPDIF format transformer or I2S-to-USB format transformer can be externally set at the receiving end of the first digital audio signal or installed in the digital-signal-format transformer 68 or in the signal-judging device 70. In addition, the second digital audio signal that conforms to I2S specification can be directly transmitted to the digital-to-analog converter 78 without the need of another SPDIF-to-I2S transformation. The digital audio signal conforming to I2S or SPDIF specification will be transmitted to the signal-judging device 70 for judging the digital audio signal is either the first digital audio signal or the second digital audio signal that should be further processed by the digital-to-analog converter 78. During practical implementation, the signal-judging device 70 can be a de-multiplexer or other device with judging function.

Please continue referring to FIG. 4. The separating module 64 of the present embodiment is composed of a frame synchronization controller 66 and a separating unit 67. The frame synchronization controller 66 will analyze and identify the correction of the received signal according to the head and the tail of the digital signal of bit-stream form and then transform the received digital signal of bit-stream form into a digital signal. In the meanwhile, the frame synchronization controller 66 will control the clock of the digital data and synchronize the digital data so as to ensure the accuracy. Afterwards, the digital signal will be processed by the separating unit 67 to be separated into the control signal and the pulse audio signal conforming to the PCM specification. During practical implementation, the separating unit 67 can be any device with signal-separation function. The separated pulse audio signal will be processed by the digital-signal-format transformer 68, and the control signal will be directly outputted for advanced analyses. The control signal, which is a digital data signal, occupies less storage space than any other audio signal. In addition, the control signal is brought with some specific information for controlling audio signals. For instance, the control signal can be used to adjust the volume of sound, and to slightly adjust the transmitting frequency channels in free space for preventing any disturbance.

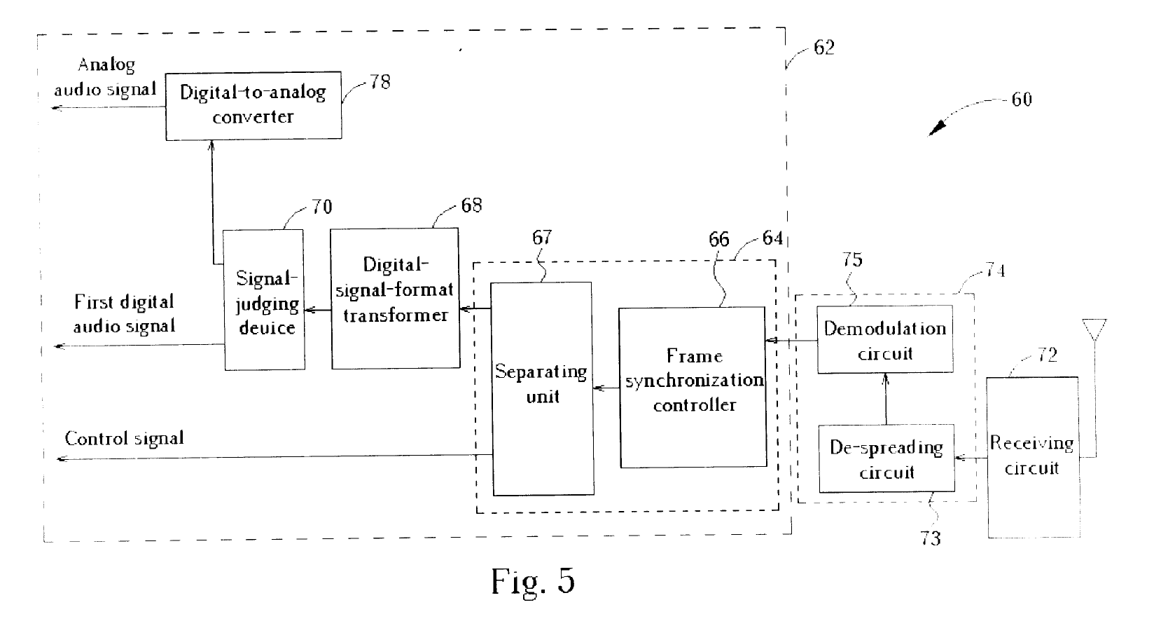

Please refer to FIG. 5, which is a functional block diagram of a receiver 60 including the apparatus 62 as shown in FIG. 4. The embodiment as shown in FIG. 5 describes the infrastructure of the receiver 60 of a wireless audio system. The receiver 60 further includes a receiving circuit 72 and a demodulation circuit 74. The receiving circuit 72 can receive a RF signal from free space and generate a corresponding baseband signal, while the demodulation circuit 74 is electrically connected to the receiving circuit 72 for executing a reversed operation of the modulation module 48. The demodulation circuit 74 is used to demodulate the baseband signal into a digital signal of bit-stream form. In the present embodiment, the demodulation circuit 74 includes a de-spreading circuit 73 and a demodulation circuit 75. The de-spreading circuit 73 executes a convolution/multiplication operation between the baseband signal and a spreading code to transform the baseband signal into a de-spreading signal. The demodulation circuit 75 applies a π/4-DQPSK demodulating operation toward the de-spreading signal to generate the digital signal of bit-stream form.

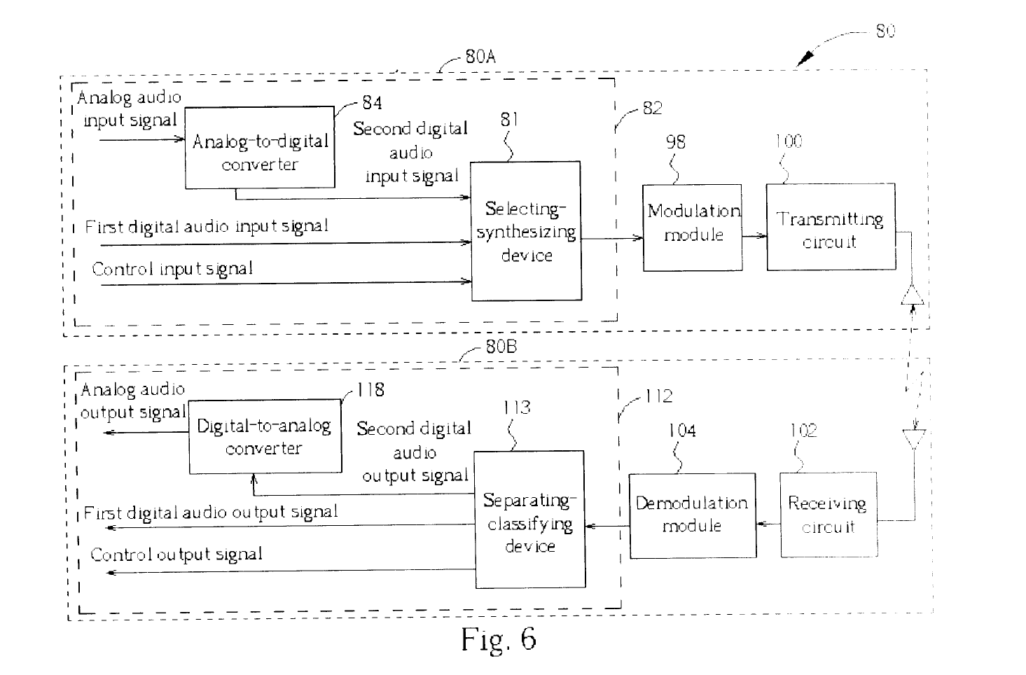

According to the above-mentioned embodiments, the embodiments shown in FIG. 2 and FIG. 3, which respectively play roles of data-transmission and data-reception, respectively correspond to the embodiments shown in FIG. 4 and FIG. 5. Combined with all the above-mentioned embodiments, an integrated wireless audio system of the present invention can be fully illustrated. Please refer to FIG. 6, which is a functional block diagram of a detailed embodiment of a wireless audio system 80 of the present invention. The wireless audio system 80 includes a transmitter 80A and a receiver 80B. The transmitter 80A is used to receive a plurality of input signals of various types. The plurality of input signals of the present embodiment include an analog audio input signal, a first digital audio input signal, and a control input signal. The transmitter 80A includes an analog-to-digital converter 84, a selecting-synthesizing device 81, a modulation module 98, and a transmitting circuit 100. The analog-to-digital converter 84 is used to transform the analog audio input signal into a corresponding second digital audio input signal. The second digital audio input signal, the first digital audio input signal, and the control input signal are inputted into the selecting-synthesizing device 81. The selecting-synthesizing device 81 can select either the first digital audio input signal or the second digital audio input signal for a signal-type transforming process. Afterwards, the transformed digital audio signal will be merged with the control input signal to generate a digital input signal of bit-stream form. The modulation module 98 electrically connected to the selecting-synthesizing device 81 can modulate the digital input signal of bit-stream form into the corresponding baseband signal, and the transmitting circuit 100 electrically connected to the modulation module 98 can transform the baseband signal into a RF signal that will be transmitted into free space. The receiver 80B is used to receive the RF signal emitted from the transmitter 80A and to output a plurality of output signals of various types. The receiver 80B includes a receiving circuit 102, a demodulation module 104, a separating-classifying device 113, and a digital-to-analog converter 118. The receiving circuit 102 is used to receive the RF signal to generate a corresponding baseband signal, and the demodulation module 104 is electrically connected to the receiving circuit 102 for modulating the baseband signal into a digital output signal of bit-stream form. The separating-classifying device 113 is used to separate the digital output signal of bit-stream form into a control output signal and a digital audio output signal. In addition, the separating-classifying device 113 will judge the digital audio output signal as either a first digital audio output signal or a second digital audio output signal. If the digital audio output signal is judged to be the first digital audio output signal, the judged first digital audio output signal will be directly outputted. If the digital audio output signal is judged to be the second digital audio output signal, the judged second digital audio output signal will be outputted to the digital-to-analog converter 118 for transforming the second digital audio output signal into a corresponding analog audio output signal. Please notice that, as shown in FIG. 6, the analog audio output signal, the first digital audio output signal, the second digital audio output signal, and the control output signal of the receiver 80B respectively correspond to the analog audio input signal, the first digital audio input signal, the second digital audio input signal, and the control input signal of the transmitter 80A.

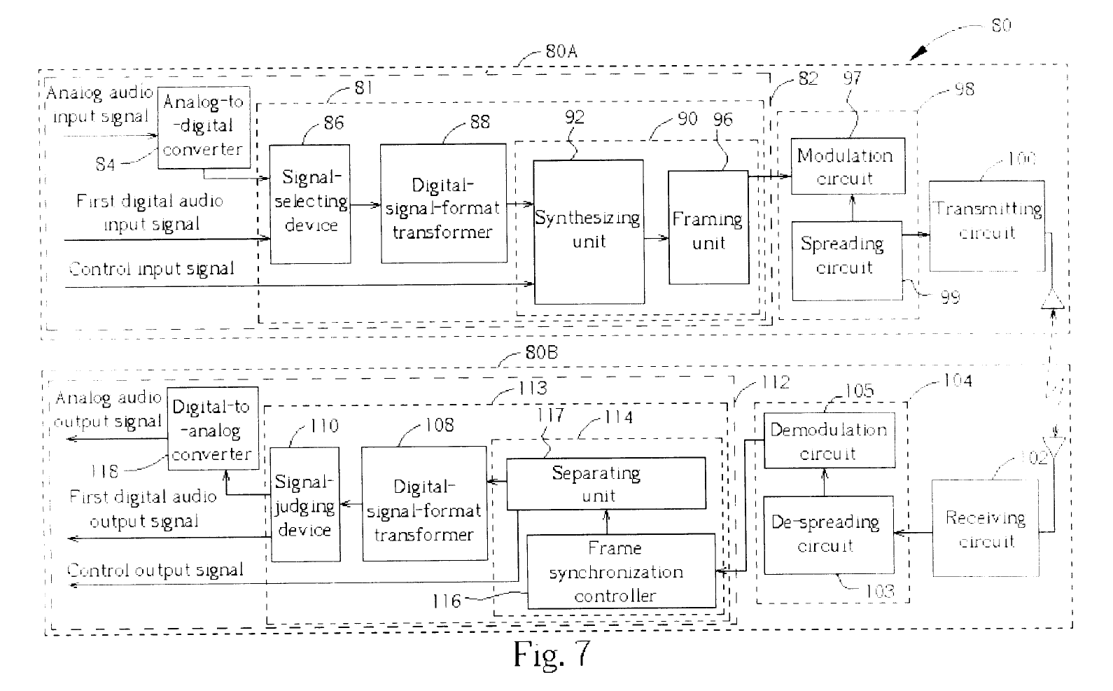

In the transmitter 80A of the wireless audio system 80 as shown in FIG. 6, the analog-to-digital converter 84 and the selecting-synthesizing device 81 can be integrally viewed as an apparatus 82 of the present invention with the characteristics of transmitting and receiving multiplexed audio and data information. The apparatus 82 can also correspond to the apparatus 32 described in FIG. 2 and FIG. 3. Similarly, in the receiver 80B of the wireless audio system 80 as shown in FIG. 6, the separating-classifying device 113 and the digital-to-analog converter 118 can be integrally viewed as another apparatus 112 of the present invention for transmitting and receiving multiplexed audio and data information. The apparatus 112 can also correspond to the apparatus 62 described in FIG. 4 and FIG. 5. Please refer to FIG. 7, which is a functional block diagram of a detailed embodiment of the wireless audio system 80 as shown in FIG. 6. As shown in FIG. 7, the selecting-synthesizing device 81 of the transmitter 80A includes a signal-selecting device 86, a digital-signal-format transformer 88, and a synthesizing module 90. The synthesizing module 90 is composed of a synthesizing unit 92 and a framing unit 96. The signal-selecting device 86 is electrically connected to the analog-to-digital converter 84. The first digital audio input signal conforms to I2S standard digital audio specifications, while the second digital audio input signal conforms to SPDIF standard digital audio specification. The digital-signal-format transformer 88 is used to transform the first digital audio input signal or the second digital audio input signal into a pulse audio signal conforming to the PCM specification. The synthesizing unit 92 of the synthesizing module 90 simultaneously receives the pulse audio signal and the control signal, and then merges these two signals. Afterwards, the framing unit 96 adds a head containing error-prevention information and a tail on the merged signal to generate a frame signal. After a clock and simultaneity control process, a digital signal of bit-stream form can be generated. The modulation module 98 of the transmitter 80A also includes a modulation circuit 97 for modulating the digital signal of bit-stream form into a modulated signal and a spreading circuit 99 for executing an operation between the modulated signal and a spreading code to generate the baseband signal.

Please continue referring to FIG. 7. The demodulation module 104 of the receiver 80B includes a de-spreading circuit 103 and a demodulation circuit 105. The de-spreading circuit 103 executes a convolution/multiplication operation between the baseband signal and a spreading code to transform the baseband signal into a de-spreading signal. The demodulation circuit 105 then modulates the de-spreading signal to generate the digital output signal of bit-stream form. The separating-classifying device 113, which corresponds to the selecting-synthesizing device 81, can be separated into a separating module 114, a digital-signal-format transformer 108, and a signal-judging device 110. The separating module 114 is used to separate the digital output signal of bit-stream form into the control output signal and the pulse audio signal. The digital-signal-format transformer 108 transforms the pulse audio signal into the digital audio output signal conforming to I2S or SPDIF standard digital audio specifications. The signal-judging device 110 can be a de-multiplexer or any other device with judging function for classifying the digital audio output signal into either the first digital audio output signal or the second digital audio output signal.

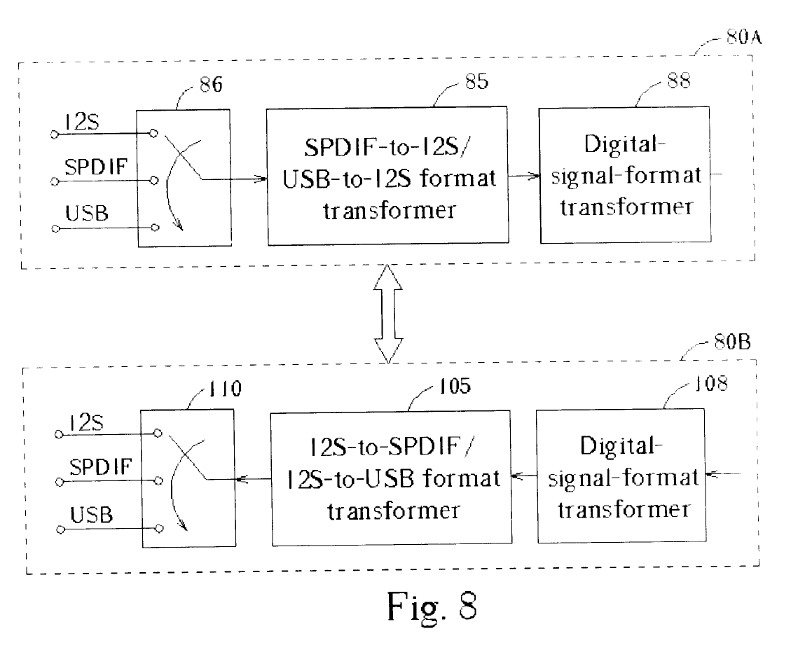

Furthermore, inheriting the characteristics disclosed in the embodiment in FIG. 2 and FIG. 4, the first digital audio signal can conform to I2S, SPDIF, or USB standard digital audio specifications. If the first digital audio signal conforms to SPDIF or USB standard specifications, another installation of an I2S-to-SPDIF or USB-to-I2S format transformer is required for conforming the first digital audio signal to I2S standard digital audio specification. Please refer to FIG. 8, which is a functional block diagram of a detailed embodiment of partial wireless audio system 80 shown in FIG. 7. The above-mentioned SPDIF-to-I2S format transformer or USB-to-I2S format transformer can be can be externally set at the receiving end of the first digital audio signal or installed in the digital-signal-format transformer 88 or in the signal-selecting device 86. Therefore, in the present embodiment, the signal-selecting device 86 can be treated as an equivalent switch device for selecting signals with various formats and an SPDIF-to-I2S/USB-to-I2S format transformer 85 is added between the digital-signal-format transformer 88 and the signal-selecting device 86. There still exists another input signal from the analog-to-digital converter 84 transmitted to the signal-selecting device 86 not shown in FIG. 8 for sake of clarification. The SPDIF-to-I2S/USB-to-I2S format transformer 85 can operate corresponding transformation according to the received signal by the signal-selecting device 86. Similarly, in the receiver 80B, there should be an I2S-to-SPDIF/I2S-to-USB format transformer 105 installed between the digital-signal-format transformer 108 and the signal-judging device 110. Similarly, there is another output signal from the signal-judging device 110 outputted to the digital-to-analog converter 118 not shown in FIG. 8 for sake of clarification.

The transmitter and the receiver of the wireless audio system according to the present invention respectively make use of an apparatus with functions of transmitting and receiving multiplexed audio and data information, so that the wireless audio system of the present invention can receive a plurality of input signals of various types and output a plurality of output signals of various types related to the input signals. In addition, a control (data) signal related to the input/output signals can be integrated into the wireless audio system to provide various options and sufficient flexibility of input/output interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for transmitting and receiving multiplexed audio and data information, the apparatus being adapted to a wireless audio system for receiving a plurality of input signals of various types, the plurality of input signals at least comprising an analog audio signal, a first digital audio signal, and a control signal, the apparatus comprising:
an analog-to-digital converter for transforming the analog audio signal into a second digital audio signal;
a signal-selecting device electrically connected to the analog-to-digital converter for selecting either the first digital audio signal or the second digital audio signal for outputting;
a digital-signal-format transformer electrically connected to the signal-selecting device for transforming the first digital audio signal or the second digital audio signal into a pulse audio signal; and
a synthesizing module electrically connected to the digital-signal-format transformer for merging the control signal and the pulse audio signal into a digital signal of bit-stream form.

2. The apparatus of claim 1, wherein the pulse audio signal conforms to a pulse-code modulation (PCM) specification.

3. The apparatus of claim 1, wherein the signal-selecting device is a multiplexer for selecting either the first digital audio signal or the second digital audio signal for outputting.

4. The apparatus of claim 1, wherein the wireless audio system further comprises a modulation module electrically connected to the synthesizing module for modulating the digital signal of bit-stream form to generate a corresponding baseband signal.

5. The apparatus of claim 4, wherein the modulation module comprises:
a modulation circuit electrically connected to the synthesizing module for modulating the digital signal of bit-stream form to generate a modulated signal; and
a spreading circuit electrically connected to the modulation circuit for proceeding operations between the modulated signal and a spreading code to generate the baseband signal.

6. The apparatus of claim 4, wherein the wireless audio system further comprises a transmitting circuit electrically connected to the modulation module for transforming the baseband signal into a RF signal and for transmitting the RF signal to a free space.

7. The apparatus of claim 6, wherein the wireless audio system further comprises a receiver comprising:
a receiving circuit for receiving the RF signal and for generating a corresponding baseband signal;
a demodulation module electrically connected to the receiving circuit for demodulating the baseband signal into a digital signal of bit-stream form;
a separating module electrically connected to the demodulation module for separating the digital signal of bit-stream form into a control signal and a pulse audio signal;
a digital-signal-format transformer electrically connected to the separating module for transforming the pulse audio signal into a digital audio signal;
a signal-judging device electrically connected to the digital-signal-format transformer for classifying the digital audio signal into either a first digital audio signal or a second digital audio signal; and
a digital-to-analog converter electrically connected to the signal-judging device for transforming the second digital audio signal into an analog audio signal.

8. The apparatus of claim 7, wherein signal-judging device is a de-multiplexer for classifying the digital audio signal into either the first digital audio signal or the second digital audio signal.

9. The apparatus of claim 7, wherein the demodulation module comprises a de-spreading circuit and a demodulation circuit, wherein the de-spreading circuit executes a convolution/multiplication operation between the baseband signal and a spreading code to transform the baseband signal into a de-spreading signal, and the demodulation circuit then demodulates the de-spreading signal to generate the digital signal of bit-stream form.

10. An apparatus for transmitting and receiving multiplexed audio and data information in a wireless audio system for receiving a digital signal of bit-stream form, the apparatus comprising:
a separating module for separating the digital signal of bit-stream form into a control signal and a pulse audio signal;
a digital-signal-format transformer electrically connected to the separating module for transforming the pulse audio signal into a digital audio signal;
a signal-judging device electrically connected to the digital-signal-format transformer for classifying the digital audio signal into either a first digital audio signal or a second digital audio signal; and
a digital-to-analog converter electrically connected to the signal-judging device for transforming the second digital audio signal into an analog audio signal.

11. The apparatus of claim 10, wherein the signal-judging device is a de-multiplexer for classifying the digital audio signal into either the first digital audio signal or the second digital audio signal.

12. The apparatus of claim 10, wherein the wireless audio system further comprises a receiving circuit and a demodulation module, wherein the receiving circuit is used for receiving a RF signal to generate a corresponding baseband signal, and the demodulation module is electrically connected to the receiving circuit for demodulating the baseband signal into the digital signal of bit-stream form.

13. The apparatus of claim 12, wherein the demodulation module comprises a de-spreading circuit and a demodulation circuit, wherein the de-spreading circuit executes a convolution/multiplication operation between the baseband signal and a spreading code to transform the baseband signal into a de-spreading signal, and the demodulation circuit then demodulates the de-spreading signal to generate the digital signal of bit-stream form.

14. The apparatus of claim 10, wherein the pulse audio signal conforms to a pulse-code modulation (PCM) specification.

15. The apparatus of claim 10, wherein the wireless audio system further comprises a transmitter for receiving a plurality of input signals of various types, the plurality of input signals at least comprising an analog audio signal, a first digital audio signal, and a control signal, the transmitter comprising:
an analog-to-digital converter for transforming the analog audio signal into the second digital audio signal;
a signal-selecting device electrically connected to the analog-to-digital converter for selecting either the first digital audio signal or the second digital audio signal for outputting;
a digital-signal-format transformer electrically connected to the signal-selecting device for transforming the first digital audio signal or the second digital audio signal into a pulse audio signal;
a synthesizing module electrically connected to the digital-signal-format transformer for merging the control signal and the pulse audio signal into a digital signal of bit-stream form;
a modulation module electrically connected to the synthesizing module for modulating the digital signal of bit-stream form so as to generate a corresponding baseband signal; and
a transmitting circuit electrically connected to the modulation module for transforming the baseband signal into a RF signal and for transmitting the RF signal to a free space.

16. The apparatus of claim 15, wherein the signal-selecting device is a multiplexer for selecting either the first digital audio signal or the second digital audio signal for outputting.

17. The apparatus of claim 15, wherein the modulation module comprises:
a modulation circuit electrically connected to the synthesizing module for modulating the digital signal of bit-stream form to generate a modulated signal; and
a spreading circuit electrically connected to the modulation circuit for proceeding operations between the modulated signal and a spreading code to generate the baseband signal.

18. A wireless audio system for transmitting and receiving multiplexed audio and data information comprising:
a transmitter for receiving a plurality of input signals of various types, the plurality of input signals at least comprising a first digital audio input signal, and a control input signal, the transmitter comprising:
a selecting-synthesizing device for transforming the first digital audio input signal into a transformed digital audio signal and then for merging the transformed digital audio signal with the control input signal to generate a digital input signal of bit-stream form;
a modulation module electrically connected to the selecting-synthesizing device for modulating the digital input signal of bit-stream form to generate a corresponding baseband signal; and
a transmitting circuit electrically connected to the modulation module for transforming the baseband signal into a RF signal and for transmitting the RF signal to a free space; and
a receiver for receiving the RF signal to output a plurality of output signals of various types, the receiver comprising:
a receiving circuit for receiving the RF signal so as to generate a corresponding baseband signal;
a demodulation module electrically connected to the receiving circuit for demodulating the baseband signal into a digital output signal of bit-stream form;
a separating-classifying device for separating the digital output signal of bit-stream form into a control output signal and a first digital audio output signal;
wherein the first digital audio output signal and the control output signal respectively correspond to the first digital audio input signal and the control input signal.

19. The wireless audio system of claim 18, wherein the modulation module comprises:
a modulation circuit being a π/4-DQPSK modulation circuit for modulating the digital signal of bit-stream form to generate a modulated signal; and
a spreading circuit electrically connected to the modulation circuit for executing operations between the modulated signal and a spreading code to generate the baseband signal.

20. The wireless audio system of claim 18, wherein the plurality of input signals further comprise an analog audio input signal.

21. The wireless audio system of claim 20, wherein the transmitter further comprises an analog-to-digital converter for transforming the analog audio input signal into a corresponding second digital audio input signal, and the selecting-synthesizing device selects either the first digital audio input signal or the second digital audio input signal for a signal-format transforming process.

22. The wireless audio system of claim 21, wherein the separating-classifying device of the receiver is used to determine that the digital audio output signal is either a first digital audio output signal or a second digital audio output signal.

23. The wireless audio system of claim 22, wherein the receiver further comprises a digital-to-analog converter electrically connected to the separating-classifying device for transforming the second digital audio output signal into a corresponding analog audio output signal.

24. The wireless audio system of claim 23, wherein the analog audio output signal and the second digital audio output signal respectively correspond to the analog audio input signal and the second digital audio input signal.

25. The wireless audio system of claim 24, wherein the selecting-synthesizing device comprises:
a signal-selecting device electrically connected to the analog-to-digital converter for selecting either the first digital audio input signal or the second digital audio input signal for outputting;
a digital-signal-format transformer electrically connected to the signal-selecting device for transforming the first digital audio input signal or the second digital audio input signal into a pulse audio signal; and
a synthesizing module electrically connected to the digital-signal-format transformer for merging the control input signal and the pulse audio signal into the digital input signal of bit-stream form.

26. The wireless audio system of claim 18, wherein the pulse audio signal conforms to a pulse-code modulation (PCM) specification.

27. The wireless audio system of claim 24, wherein the separating-classifying device comprises:
a separating module for separating the digital output signal of bit-stream form into the control output signal and the pulse audio signal;
a digital-signal-format transformer electrically connected to the separating module for transforming the pulse audio signal into the digital audio output signal; and
a signal-judging device electrically connected to the digital-signal-format transformer for determining the digital audio output signal into either the first digital audio output signal or the second digital audio output signal.

28. The wireless audio system of claim 18, wherein the pulse audio signal conforms to a pulse-code modulation (PCM) specification.

29. The wireless audio system of claim 18, wherein the demodulation module comprises a de-spreading circuit and a demodulation circuit, wherein the de-spreading circuit executes a convolution/multiplication operation between the baseband signal and a spreading code to transform the baseband signal into a de-spreading signal, and then the demodulation circuit applies a π/4-DQPSK demodulating operation toward the de-spreading signal to generate the digital signal of bit-stream form.
